(19) United States
(12) Patent Application Publication
(10) Pub. No.: US 2010/0242806 A1
(43) Pub. Date: Sep. 30, 2010

(54) Photocatalytically activated structural components composed of a matrix bound with a mineral binder, as well as method for production of the structural components

(75) Inventor: Klaus Droll, Mainz (DE)

Correspondence Address: COLLARD & ROE, P.C., 1077 NORTHERN BOULEVARD, ROSLYN, NY, 11576, US

(73) Assignee: Dyckerhoff AG

(21) Appl. No.: 12/661,451

(22) Filed: Mar. 17, 2010

(30) Foreign Application Priority Data
Mar. 24, 2009 (DE) 10 2009 014 600.8

(51) Int. Cl. C04B 11/00; C04B 14/02; C04B 2/02; B28B 23/00; B28B 3/02; B28B 1/04; B28B 1/08; B28B 1/14

(52) U.S. Cl. 106/772; 106/638; 106/792; 264/271.1; 264/129; 264/255; 264/71

(57) ABSTRACT

A structural component on the basis of a mineral, crystalline binder matrix composed of hardened cement and/or construction lime and/or gypsum, wherein the matrix can have aggregates and/or additives and/or admixtures, forms a surface that receives light, in its usability or use, on which surface photocatalytically active particles are situated. The particles are situated and fixed in place only on the surface of the structural component. The remainder of the structural component body does not have the particles. A method for production of the structural components is also provided.

### CROSS REFERENCE TO RELATED APPLICATIONS

Applicant claims priority under 35 U.S.C. §119 of German Application No. 10 2009 014 600.8 filed Mar. 24, 2009.

### BACKGROUND OF THE INVENTION

1. Field of the Invention

The invention relates to a structural component on the basis of a mineral, crystalline binder matrix and a method for production of the structural component.

Structural components on the basis of a mineral-bound, crystalline matrix, with which the invention concerns itself, are structural elements that are intended to be used in such a way that in the installed state, for example in a building, they form at least one surface that receives light. Such structural components are produced from an aqueous mixture of at least one mineral binder, such as cement, construction lime and/or gypsum or anhydrite, and generally aggregates such as sands, gravels, and crushed stones, for example, and/or additives such as flue ash, stone meals, for example, and/or admixtures such as liquefiers, stabilizers, hydrophobization agents, for example.

These structural components are finished concrete parts produced in form boards or molds, for example, or concrete components produced on site, in form boards. Equally, these structural components are, for example, concrete goods. In other words, these structural components can be concrete products such as concrete paving stones, concrete pipes, sidewalk and paving panels, curbstones and edging stones, railway platform edgings or the like. Furthermore, these structural components are, for example, concrete ashlars or cement flooring and terrazzo floors or mortar or stucco on structural element surfaces. The production and composition of these structural components are described, for example, in the handbook “Betonfertigteile—Betonwerkstein—Terrazzo” [Finished concrete parts—concrete ashlars—terrazzo], Verlag Bau+Technik GmbH [publisher], Düsseldorf, 1999, particularly in Chapters 5, 6, and 7. The invention, however, also relates to structural components bound with gypsum or anhydrite, particularly finished products bound with gypsum, such as sheetrock panels, gypsum walls, anhydrite floors, and the like.

2. The Prior Art

It is known to coat surfaces of hardened structural components with photocatalytically active nanoparticles such as TiO₂ particles, so that self-cleaning of the surface can be achieved. Aside from this self-cleaning effect, surfaces coated with a photocatalyst film can actively contribute to cleaning of the air that surrounds them, in that toxic gases such as NO and NO are photocatalytically oxidized to form NO₂, for example, resulting in non-toxic nitrate ions in an aqueous milieu. Organically bound films, stuccos or mortars have been used as coatings, which are subsequently applied to the structural components after completion of a building structure or after hardening of the components, for example using aqueous suspensions (for example WO 01/00541 A1, EP 784 034 A1, EP 614 682 A1, DE 10 2005 057 770 A1, US 2007/0027015 A1, EP 1 020 564 A1, US 2006/0147756 A1, DE 10 2005 057 747 A1). In this connection, pre-mixes composed of a hydraulic binder and photocatalytically active particles are also used for the production of aqueous mixtures (EP 1564194 A2), and the aqueous mixtures are sprayed onto or atomized onto the surfaces (EP 1020564 A1).

All these different types of coatings generally have the disadvantage that the other incidental components that are present aside from the photocatalytically active nanoparticles can impair the effectiveness of photocatalysis and/or, in terms of amount, contain too many of the expensive photocatalytical nanoparticles in an inactive state and/or the coating comes loose from the substratum due to weathering influences and/or the coating is destroyed by ambient influences.

Another relatively expensive method is to mix the photocatalytically active nanoparticles into the basic mixture of the structural components. In this connection, although a very large amount of nanoparticles is required, binding of the nanoparticles into the matrix is much stronger than in coatings. For this reason, their effect is more permanent (e.g. EP 885 857 A1, IT 1 286 492 A1).

### SUMMARY OF THE INVENTION

It is an object of the invention to equip structural components, particularly molded structural components, of the type described above, with small amounts of photocatalytically active particles, in simple manner and nevertheless achieve a very effective, permanent photocatalytic effect.

These and other objects are achieved by a component and a method for production according to the invention. Advantageous further embodiments of the invention are discussed below.

According to the invention, known photocatalytically active particles, for example TiO₂ particles, having particle sizes in the nano range, for example between 1 and 1000 nm, and/or in the micro range, for example between 1 and 50 μm, are transferred or applied to a surface, which receives light in the installed state, of a non-hardened, mineral-bound structural component, particularly a structural component forming a matrix of cement. Non-hardened means that the structural component is still in the fresh state, i.e. in the so-called green or young state (also called fresh structural component hereinafter), and not yet in the solid state (also called solid structural component hereinafter), i.e. the mineral binders have not yet developed their complete crystalline solid structure, as is the case with solid concrete or hardened gypsum structural components, for example.

According to the invention, transfer of the photocatalytically active particles takes place, for example during shaping of the structural component from a plastic or ductile mixture, which has water/binder values between 0.3 and 0.7, for example, or shortly after shaping, before the hardening reaction of the binder starts, or at the latest shortly after it starts, for example after unmolding of the structural component, which is firm but not yet solidified, and is in a so-called rest period of between 0.5 to 6 hours of the fresh structural component, for example (see, in this regard, for example, Zement, Taschenbuch [Cement, Handbook] 2002, page 114 to 123, Point 4.1.2, page 142 to 146, Point 5.2, page 301 to 303, Point 4.5). Accordingly, transfer of the particles takes place particularly during stiffening and/or setting of the cement glue or of the gypsum or of the construction lime. A person skilled in the art can determine the degree of maturity or the viscosity of a mixture at which adhesive absorption of the particles on the surface is possible, for every mixture, without great effort.

It is advantageous if, during transfer of the particles to the surface of a fresh structural component, the ductile mixture is vibrated or shaken or tamped at least in the surface region, and, in particular, if thixotropic processes are initiated in this connection, and if small proportions of water accumulate on the surface of the structural component equipped with the photocatalytically active particles in this connection.

It is surprising that the photocatalytically active particles can be firmly and permanently disposed on, i.e. bound into the surface of a fresh structural component, for example of a fresh concrete structural component, without additional adhesion-imparting agents or adhesives, and remain firmly integrated into the surface of the structural component even after hardening of the structural component. Because the particles do not react chemically with components of the structural component mixture, it would have been expected that the particles would lie loosely on the surface and would readily fall off or drop off in the form of sand. Obviously, the particles are first held in place on the structural component surface by means of capillary forces, by capillaries. These capillaries are known to be produced by water of the fresh mixture, when the water migrates from the surface of the structural component into the interior of the structural component, during hardening, and is used up there during the solidifying binder crystal formation (for example calcium silicate hydrate and/or calcium aluminate hydrate phase formation and/or gypsum dihydrate formation). Subsequently, the particles are captured into the crystal needle or crystal platelet structure of the hardened binder of the hardened cement, the so-called cement stone, and held in place mechanically there, whereby freely accessible particles or surface regions remain.

Photocatalytically active particles, i.e. particles that can be used are, for example, TiO₂ and/or ZnO and/or other particles, particularly mineral-modified particles having a broader absorption spectrum, for example as described in DE 10 2005 057 770 A1, DE 10 2005 057 747 A1 or WO 01/00541 A1, which can be excited photocatalytically by UV radiation and/or visible light. The photocatalytically active particles are used, for example, in the form of dry powders having particle grain sizes of 5 nm to 50 μm, for example, particularly of 20 to 100 nm, as so-called nanoparticles and/or as microparticles having grain sizes of 0.1 to 50 μm, for example, particularly 0.1 to 1 μm.

The photocatalytically active particles can also be applied, for example, in the form of aqueous powder suspension droplets having droplet diameters of 0.1 to 1000 μm, for example, particularly of 1 to 100 μm.

The photocatalytically active particles are disposed so as to be uniformly distributed over a surface, for example at 0.1 to 50, particularly at 2 to 10 area-%, which means that the surface is covered with corresponding amounts of the particles. The coverage can be distributed homogeneously over the area, or non-homogeneously, for example according to one or more patterns, or can be distributed over the area completely irregularly, as a computer dot distribution.

### BRIEF DESCRIPTION OF THE DRAWINGS

Other objects and features of the invention will become apparent from the following detailed description considered in connection with the accompanying drawings. It is to be understood, however, that the drawings are designed as an illustration only and not as a definition of the limits of the invention.

In the drawings,

FIG. 1 schematically shows a surface of a structural component in accordance with an embodiment of the invention; and

FIGS. 2 and 3 are diagrams showing the photocatalytic activity of concrete surfaces in accordance with embodiments of the invention.

### DETAILED DESCRIPTION OF PREFERRED EMBODIMENTS

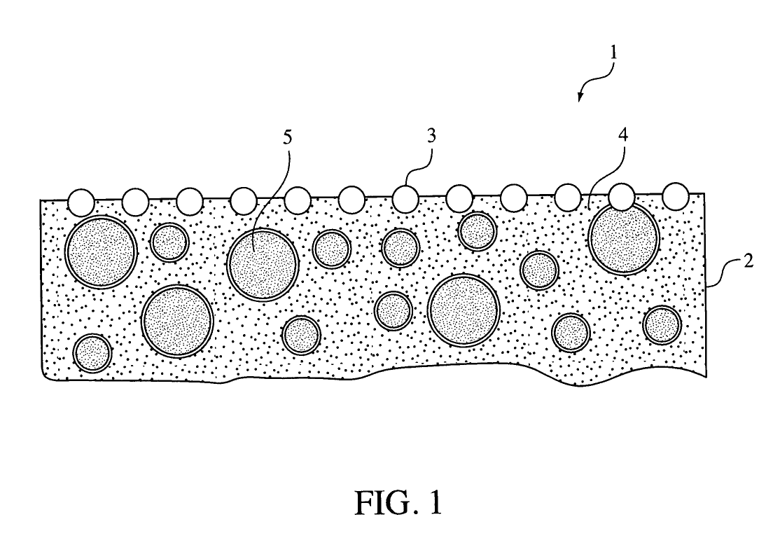

FIG. 1 schematically shows a surface 1 of a structural component 2 composed of a concrete containing aggregates 5, having a binder matrix 4 in which photocatalytically active particles 3 are disposed distributed over the area only of the surface 1. These particles are partly bound into the binder matrix 4 and show, i.e. demonstrate free particle surface at the surface of the structural component 2.

Application of the photocatalytically active particles takes place directly or indirectly onto the surface of the fresh structural component. Directly, application takes place by way of dusting, sprinkling, spraying or jetting, if the fresh structural component is still in the mold or the form boards, onto the free, i.e. form-board-free surface, or, after unmolding, onto a surface intended for this purpose. When application takes place after unmolding, aqueous powder suspension droplets, i.e. colloid droplets are preferably applied, because the liquid of the droplets, together with the photocatalytically active particles contained in it, is held particularly tightly by means of capillary forces in effect at the surface of the structural component, until the crystal formation of the binder substance binds the particles and the water of the droplets evaporates or is used up in the interior of the structural component, for crystal formation of the hydrate phases of the binder.

Indirectly, transfer takes place by applying the photocatalytically active particles, as powder or droplets, onto a form-board wall or mold wall, for example in the case of form boards that are in place, onto the bottom wall, for example by way of sprinkling, spraying, jetting or atomizing them on, before the fresh structural component mixture is placed into the mold or the form boards. The mold wall of the form board wall transfers the particles onto/into the fresh structural component surface after introduction of the fresh structural component mixture, in surprising manner, almost without leaving any residues on the mold wall or form board wall.

It can be practical to carefully smooth the surface that has the particles, after application of the particles, or to carefully roll or rub the particles in.

Devices independent of form boards or independent of molds may be used for indirect transfer. For example films or rollers on which the particles were previously disposed may be used. The particles may be transferred by laying the films down and subsequently pulling them off, or by rolling the particles on with the roller, onto the fresh structural component surface.

According to a particular embodiment of the invention, the photocatalytically active particles are mixed in dry form with a powder, for example a binder powder or binder meal, for example composed of cement, construction lime and/or gypsum or anhydrite, before application. The binder meal particles then react, after application of the dry binder/active particle mixture onto the surface, with the water present on the surface of the fresh structural component, and form binder phases, for example gels, which first bind the photocatalytically active particles onto the surface, during stiffening and setting, and, during subsequent hardening of this additional binder, bind the particles into an additional crystal structure of this binder. Mixtures of photocatalytically active particles and binder powder are practical that have weight amount ratios of 90:10 to 10:90, particularly of 80:20 to 20:80. The binders can be used at grain size ranges between 10 nm and 100 μm. Preferably, in this connection, cements having grain size ranges between 0.1 and 50 μm and/or micro-cements having grain size ranges between 0.1 and 10 μm are used. In particular, a binder is used that is also used for production of the structural component, and is a cement, for example.

The mixture of powder, i.e. binder powder and photocatalytically active particles, can also be batched up as a suspension and applied in droplet form, with the droplet diameters indicated above, for example.

The invention can particularly be used in the production of planar shaped finished parts, for example of paving stones or concrete ashlars, in which a high-quality, expensive functional facing concrete is first applied to form boards that are in place, and then the backing concrete that guarantees the static function is filled into the form boards. In this connection, the photocatalytically active particles are applied to the bottom of the form boards or the mold before introduction of the concrete mixture. During introduction of the concrete, it is practical to perform vibration and/or shaking and/or tamping.

Another particular application of the invention can take place in the production of concrete paving stones or finished concrete parts, in which the core or backing concrete is first filled into the molds in the consistency of damp soil, onto which the facing concrete having the desired surface properties is then applied in a second filling step, and compacted using the shaking/pressing method (shaking under load). The photocatalytically active particles are applied to the facing concrete particularly during the shaking/pressing method, or shortly afterward.

In the same manner, cement flooring can be provided, on the surface, with the photocatalytically active particles, after they have been introduced into a delimited field, i.e. into a delimited mold, and smoothed, for example by means of sprinkling, spraying, or dusting them on. Furthermore, in this connection, after the application, slight, careful rubbing of the photocatalytically active particles into the surface can also take place.

Application of the photocatalytically active particles onto a surface of a fresh structural component means, for one thing, direct coverage of a free surface of a green or young structural component situated in mold or in form boards with the particles, before it hardens. For application, only a certain time window is available. The time window depends on the type of binder and/or the composition of the binder or binder mixture, for example the concrete mixture. In every case, the time window can be determined empirically, in simple manner. The time window is departed from when the particles are no longer absorbed because hardening has proceeded too far, and no sufficient adhesion forces and/or capillary forces are present any longer.

In the case of the presence of cement as a binder in fresh, i.e. green or young structural components, application takes place—if no additives that delay the concrete are added—for example, depending on the type of cement, at the latest four hours after mixing with water, when mixing water standing on the surface dries up. If construction lime or gypsum is the binder, application takes place, at the latest, before the surface has dried.

In the case of direct application, the particles are powdered on, for example, and/or sprinkled on and/or jetted on and/or sprayed on.

Application of the photocatalytically active particles onto the surface of a fresh concrete means, for another thing, indirect application. With indirect application, the photocatalytically active particles are first disposed on the bottom wall of a mold or form boards, for example, or on a side wall of a mold or form boards, and subsequently the fresh mass of the structural component is placed into the mold or into the form boards. In this connection, the photocatalytically active particles are absorbed by the surface of the fresh structural component, and adhere to this surface after unmolding, i.e. after removal of the form boards.

For this indirect application, the photocatalytically active particles are first disposed on an intermediate carrier element, for example a thin film or a roller. In the case of a film as an intermediate carrier element, the film can also be positioned on a wall of the mold or the form board wall, whereby the surface of the film covered with photocatalytically active particles faces the interior of the mold or form boards. From the film, on which the particles are disposed to adhere slightly, the particles are absorbed by the surface of the fresh structural component that contacts the film, and remain there after removal of the form boards.

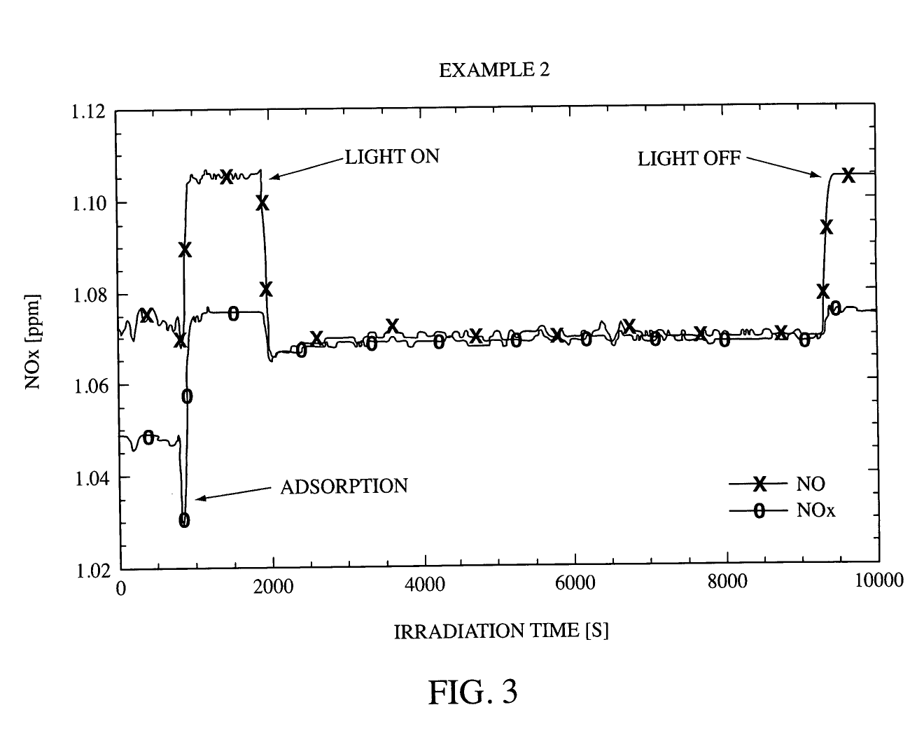

A person skilled in the art can easily recognize, when looking at the finished structural component removed from the mold or the form boards and analyzing the surface of the structural component, whether or not the photocatalytically active particles were applied within the time window of the fresh state of the structural component. For example, one can determine that the particles were applied within the time window where the particles are firmly bound into the crystalline structural component surface matrix, and are not lying around on the surface in non-bound form (see FIG. 3).

In the production of structural components according to the state of the art, in which the photocatalytically active particles are mixed into the mixture, it is true that particles are present at the surface of the structural component in the fresh or hardened state; however, these particles are less active because their surface is covered with foreign substances, for example pore solution residues, for example dissolved Ca(OH)₂ and Ca₂SO₄. At the same coverage per amount of structural component surface, this covering has been proven to lead to reduced activity.

Unusually many advantages are accumulated by means of the invention. Very much smaller amounts of expensive photocatalytically active particles are needed to achieve the same photocatalytic effect. The available amount of the particles of the surface can be predetermined in simple manner, by simple metering. The coverage of the surface with regard to the amount and/or the type of particles and/or the grain sizes can take place by zones, for example, using templates, for example. Dry powders and/or suspensions, for example with water or with other rapidly evaporating liquids, for example alcohols, and/or liquid colloid mixtures can be used. A mixing problem does not occur, in dry powders and/or suspensions as it does in the case of fresh binder mixtures. The particles can be mixed and dispersed only with significant effort into such fresh binder mixtures in order to achieve the required homogeneous distribution of the particles in the mixture. According to the invention, however, nanoparticles can be applied just as easily as microparticles, or mixtures of nanoparticles and microparticles.

In every case, however, the photocatalytic activity of the particles can be significantly increased, probably because they are more freely accessible at the surface of the structural component than in the case of components that contain the particles mixed into them, with the same amount at the surface of the structural components.

Another significant advantage of the invention is that the structural component does not experience any loss in strength due to the addition of the photocatalytically active particles. In the case of structural components into which the photocatalytically active particles have been mixed, these particles weaken their strength, because these inert particles do not make any contribution to strength.

### Example 1

A freshly batched-up concrete with a water/cement value of 0.5 is smoothed after compacting. A thin film of water forms on the surface. After about 1.5 hours, the thin film of water standing on the surface of the concrete begins to contract and the surface becomes matte damp, indicating the end of the rest phase. At this point in time, the capillary forces are optimal, and then a TiO₂ pigment (specific surface about 125 m²/g according to BET) is uniformly sprinkled over the concrete surface. The amount is 10-15 g TiO₂ particles/m². This amount corresponds to a surface coverage of about 10%. The cement hardens and fixes the pigment particles in place at the surface of the concrete.

After 28 days storage under standard conditions, at 20° C. and 65% relative humidity, the photocatalytic activity of the surface is measured.

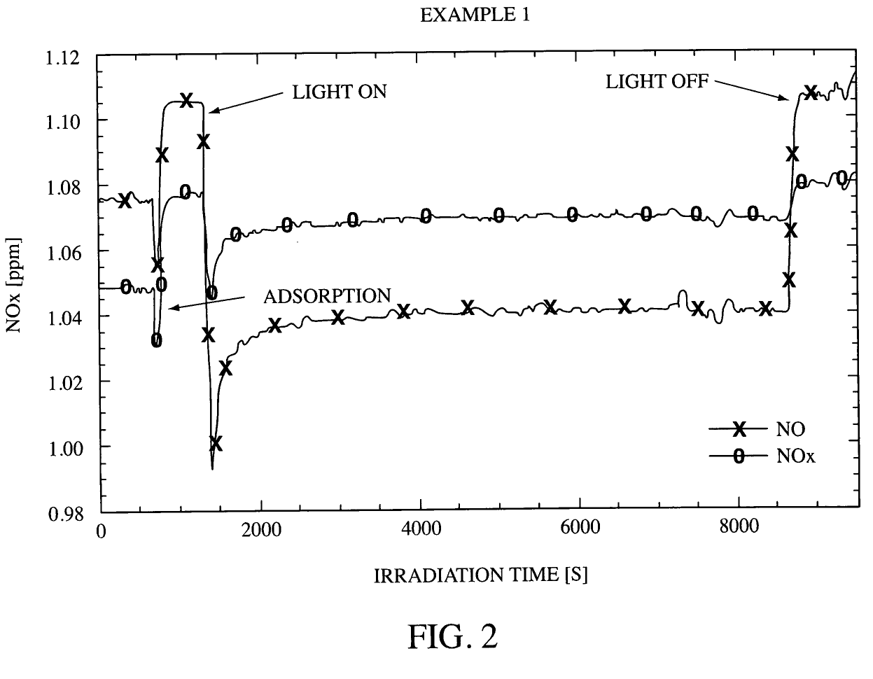

FIG. 2 shows the photocatalytic activity of the concrete surface resulting from the decomposition of NOx or NO on a concrete sample surface 5×10 cm in a gas flow of 3 l/min at an NOx and NO concentration of approximately 1 ppm NO or NOx at an irradiation with UV(A) light of 1 mW/cm² (measurement with an NO/NOx analyzer with fluorescence detector).

At the beginning of the measurement, the sample surface, in the dark (without 5 UV(A) irradiation) has a gas stream of 1, approximately 1.15 ppm NO or 1.075 ppm NOx flowing over it for approximately 15 min. In this connection, a small absorption rate of these gases is determined at first.

After approximately 20 min, UV(A) light is then turned on. Immediately, the NOx or NO content above the sample surface is reduced by 3.0% or 10.5%, respectively, and drops to equilibrium values at 1.2% or 6.3%, respectively, after another 100 minutes of irradiation.

After 100 min, the UV(A) light is turned off again, and the initial values re-occur in the gas stream.

### Example 2

A freshly batched-up concrete is produced in accordance with Example 1.

A thin film of water forms on the surface. After about 1.5 hours, the thin film of water standing on the surface of the concrete begins to contract—the surface becomes matte damp (end of the rest phase). Parallel to this process, a smooth PE film is electrostatically charged by rubbing it on cotton, and dusted with photocatalytically reactive TiO₂ pigment (specific surface about 4 m²/g according to BET). Immediately after the about 1.5 hours of the rest phase, the film is placed onto the dried concrete surface and weighted down with a roller, for example. Afterwards, the film is pulled off. About 5 g TiO₂ particles/m² remain on the surface (area coverage about 3%). The pigment particles are fixed in place as the cement hardens.

After 28 days storage under standard conditions, at 20° C. and 65% relative humidity, the photocatalytic activity of the surface is measured in accordance with the method indicated in Example 1.

FIG. 3 shows the photocatalytic activity of the concrete surface resulting from the decomposition of NOx or NO on a concrete sample surface 5×10 cm in a gas flow of 3 l/min at an NOx and NO concentration of approximately 1 ppm NO or NOx at an irradiation with UV(A) light of 1 mW/cm² (measurement with an NO/NOx analyzer with fluorescence detector).

At the beginning of the measurement, the sample surface, in the dark (without 5 UV(A) irradiation) has a gas stream of 1.125 ppm NO or 1.075 ppm NOx flowing over it for approximately 10 min. In this connection, a small absorption rate of these gases is determined at first.

After approximately 20 min, UV(A) light is then turned on. Immediately, the NOx or NO content above the sample surface is reduced by 1.3% or 4.25%, respectively, and drops to equilibrium values at 0.5% or 3.5%, respectively, after another 100 minutes of irradiation.

After 100 min, the UV(A) light is turned off again, and the initial values re-occur in the gas stream.

With the film, a more uniform distribution of the particles on the concrete surface can be achieved. Furthermore, the particle amount can be reduced, while achieving approximately the same effect.

Although only a few embodiments of the present invention have been shown and described, it is to be understood that many changes and modifcations may be made thereunto without departing from the spirit and scope of the invention.

What is being claimed is:

1. A structural component comprising:
(a) a mineral, crystalline binder matrix forming a light-receiving surface and a remainder portion, said matrix comprising at least one material selected from the group consisting of hardened cement, construction lime, and gypsum; and
(b) photocatalytically active particles fixed in place on said surface;
wherein said remainder portion contains no photocatalytically active particles.

2. The structural component according to claim 1, further comprising at least one further material selected from the group consisting of aggregates, additives, and admixtures disposed in the matrix.

3. The structural component according to claim 1, wherein the surface comprises a surface zone containing the particles, the surface zone having a maximum depth of 50 μm deep.

4. The structural component according to claim 3, wherein the surface zone has a maximum depth of 5 μm deep.

5. The structural component according to claim 3, wherein the surface zone has a maximum depth of 2 μm deep.

6. The structural component according to claim 1, wherein the particles are applied to the surface before or during stiffening of the matrix.

7. The structural component according to claim 1, wherein the particles are applied to the surface before or while solidifying consistency occurs in the matrix.

8. The structural component according to claim 1, wherein the particles comprise at least one of TiO₂ particles, ZnO particles, mineral-modified TiO₂ particles, and mineral-modified ZnO particles.

9. The structural component according to claim 1, wherein the particles are present in amounts of 1 to 100 g/cm² surface.

10. The structural component according to claim 1, wherein the particles are present in amounts of 2 to 50 g/cm² surface.

11. The structural component according to claim 1, wherein the matrix comprises a hardened binder having a crystal structure and the particles are mechanically integrated into the crystal structure of the hardened binder.

12. The structural component according to claim 1, wherein the matrix comprises cement stone.

13. The structural component according to claim 1, wherein the particles comprise nanoparticles having grain sizes of 1 to 100 nm.

14. The structural component according to claim 1, wherein the particles comprise nanoparticles having grain sizes of 20 to 100 nm.

15. The structural component according to claim 1, wherein the particles comprise microparticles having grain sizes of 0.1 to 50 μm

16. The structural component according to claim 1, wherein the particles comprise microparticles having grain sizes of 0.1 to 1 μm.

17. The structural component according to claim 1, wherein the particles are disposed on the surface at 0.1 to 50 area-%.

18. The structural component according to claim 1, wherein the particles are disposed on the surface at 2 to 10 area-%.

19. The structural component according to claim 1, wherein the particles are homogeneously distributed on the surface.

20. The structural component according to claim 1, wherein the particles are uniformly distributed on the surface.

21. The structural component according to claim 1, wherein the particles are distributed irregularly in the surface.

22. The structural component according to claim 1, wherein the particles are distributed in a pattern on the surface.

23. A method for production of a molded structural component having a mineral binder matrix comprising at least one material selected from the group consisting of hardened cement, construction lime, and gypsum, the method comprising the steps of:
(a) batching up a mass from at least one mineral binder and water;
(b) subsequently introducing the mass into a mold or a plurality of formboards;
(c) applying photocatalytically active particles during or after molding to at least one surface of the mass before the mass hardens; and
(d) hardening the mass to form a structural body comprising the particles situated on the at least one surface, the at least one surface receiving light for actuating the photocatalytically active particles.

24. The method according to claim 23, wherein the mass further comprises at least one further material selected from the group consisting of aggregates, additives, and admixtures and the mineral binder matrix contains the at least one further material.

25. The method according to claim 23, wherein the photocatalytically active particles are applied to the at least one surface during solidification of the at least one mineral binder.

26. The method according to claim 23, wherein the particles are applied to the mold or walls of the form board before introduction of the mass and subsequently the mass is introduced into the mold or the form boards.

27. The method according to claim 23, wherein the particles are applied to an exposed surface of the mass in the mold, onto an exposed surface of the mass after unmolding from the form boards, or onto an exposed surface of the mass after removal of the form boards.

28. The method according to claim 23, wherein the particles comprise at least one of TiO₂ particles, ZnO particles, mineral-modified TiO₂ particles, and mineral-modified ZnO particles, the particles being sized in at least one range selected from the group consisting of 1 and 100 nm, 20 and 100 nm, 0.1 and 50 μm, and 0.1 and 1 μm.

29. The method according to claim 23, wherein the particles are applied in at least one form selected from the group consisting of powder and suspension droplets having at least one particle situated in each droplet.

30. The method according to claim 23, wherein the particles are applied in an amount so as to take up 0.1 to 50 area-% of the at least one surface.

31. The method according to claim 23, wherein the particles are applied in an amount so as to take up 2 to 10 area-% of the at least one surface.

32. The method according to claim 23, wherein before application, the particles are mixed in dry form with at least one mineral binder powder.

33. The method according to claim 32, wherein the at least one mineral binder is formed from the at least one mineral binder powder.

34. The method according to claim 32, wherein the at least one mineral binder powder comprises a cement.

35. The method according to claim 32, wherein the particles and the at least one mineral binder powder are mixed together in weight amount ratios of 100/0 to 1/99 wt.-%.

36. The method according to claim 32, wherein the particles and the at least one mineral binder powder are mixed together in weight amount ratios of 90/10 to 20/80 wt.-%.

37. The method according to claim 23, wherein molds are used to produce cement-bound paving stones or concrete ashlars.

38. The method according to claim 37, wherein concrete paving stones or finished concrete parts are produced by first filling a core concrete into the molds and then in a second filling step, applying a facing concrete having selected surface properties onto the core concrete, and compacting the facing concrete, wherein the particles are applied to an exposed surface of the facing concrete in the mold.

39. The method according to claim 38, wherein the core concrete is pre-compacted before the second filling step.

40. The method according to claim 38, wherein the facing concrete is compacted by a shaking/pressing method and the particles are applied before the shaking/pressing method or afterwards.

41. The method according to claim 37, wherein the cement-bound paving stones or the concrete ashlars are produced by first applying a layer of a functional facing concrete mixture to form boards that are in place and then filling a backing concrete mixture into the form boards, wherein the particles are applied to a bottom portion of the form boards or of the mold before introduction of the facing concrete mixture.

42. The method according to claim 41, wherein at least one of vibration, shaking, and tamping takes place during introduction of each of the concrete mixtures.
